(19) United States
(12) Patent Application Publication
(10) Pub. No.: US 2009/0196145 A1
(43) Pub. Date: Aug. 6, 2009

(54) OPTICAL INFORMATION RECORDING/REPRODUCING APPARATUS, OPTICAL INFORMATION REPRODUCING APPARATUS, AND OPTICAL INFORMATION RECORDING MEDIUM

(75) Inventors: Shinichi Tatsuta, Tokyo (JP); Yuichiro Yamamoto, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/330,900

(22) Filed: Dec. 9, 2008

(30) Foreign Application Priority Data
Dec. 11, 2007 (JP) 2007-319606

(51) Int. Cl. G11B 7/00

(52) U.S. Cl. 369/103; G9B/7

(57) ABSTRACT

An optical information recording/reproducing apparatus includes an irradiation optical system of an information beam to an optical information recording medium that can record information as hologram by using interference fringes produced due to interference between the information beam that carries the information and a reference beam; a first light-reducing element placed in an optical path of the irradiation optical system of the information beam and reduces light intensity of part of the information beam; a detector that detects a reproduction beam emitted from the optical information recording medium; and a second light-reducing element placed in an optical path of the reproduction beam extending from the optical information recording medium to the detector, and that reduces light intensity of the reproduction beam emitted from a first area other than a second area, in which information is recorded with the information beam of which light intensity is reduced by the first light-reducing element.

### CROSS-REFERENCE TO RELATED APPLICATIONS

This application is based upon and claims the benefit of priority from the prior Japanese Patent Application No. 2007-319606, filed on Dec. 11, 2007; the entire contents of which are incorporated herein by reference.

### BACKGROUND OF THE INVENTION

1. Field of the Invention

The present invention relates to an optical information recording/reproducing apparatus for recording and reproducing information as hologram in and from an optical information recording medium in which the information is recorded as hologram, an optical information reproducing apparatus, and the optical information recording medium.

2. Description of the Related Art

Optical information recording media include a compact disk (CD), a digital versatile disk (DVD), and a high-definition digital versatile disc (HD DVD). The optical information recording medium responds to an increase in recording density so far mainly by making a wavelength of a laser beam shorter and by increasing the numerical apertures (NA) of an objective lens. However, both the methods seem to be approaching the limit by some technical reasons, and it is therefore required to increase the recording density by other means and systems.

Recently, among various approaches, a volume-recording type high-density optical recording using holography (hereinafter, “holographic memory”) and a recording/reproducing device of the holographic memory (hereinafter, “holographic-memory recording/reproducing device”) are being developed for practical use. A recording system of the holographic memory is implemented by irradiating an information beam and a reference beam to one location in a recording medium and by recording light interference fringes formed by the information beam and the reference beam upon the irradiation, in the recording medium. More specifically, the information beam carries information by spatially modulating a laser beam by a space modulator such as a liquid crystal element and a digital micromirror device, and the reference beam has the same wavelength as that of the information beam and is generated usually from the same light source as the information beam.

By irradiating only the reference beam to the holographic memory for reproduction, the recorded information beam is reproduced to obtain the information which has been modulated upon the recording. The DVD or the like is based on a so-called surface recording system of recording a recording mark on a recording surface, while a holographic optical disc is based on a volume recording system capable of recording information in a thickness direction of an information recording layer. Therefore, the holographic optical disc is expected to have a high recording density as compared with that of the DVD or the like.

In the case of the DVD or the like, the recording mark generally indicates bit data for on/off, while in the case of the holographic memory, the information beam is collectively modulated by a comparatively large amount of information and recorded as interference fringes. A set of information is a pattern of the information beam stored in the recording medium, and is a minimum unit of a two-dimensional bar code formed by black and white dots for recording and reproduction. The set of information is called page data.

There is a multiple recording system as one of the methods of increasing the recording density of the holographic memory. The multiple recording system is a system of recording a plurality of page data in one location of the holographic memory. The recording is represented by angular multiplexing recording such that an angle of irradiating a laser beam is shifted, and by shift multiplexing recording such that a position irradiated with a laser beam is slightly shifted.

In any of the multiple recording systems except for a specific case, the information beam is collected by a lens and then irradiated to a medium at or near a focus position. It is well known that a light-intensity distribution at or near the focus position is acquired by subjecting a modulation pattern of the information beam to Fourier transform or to Fresnel transform. However, one of features of the light-intensity distribution is existence of a spot called a 0th-order beam with extremely high light intensity at the center of the light-intensity distribution.

The light intensity of the 0th-order beam is generally 10 times to 1000 times, or more, higher than the light intensities of the other beams. Therefore, interference fringes occurring thereby have the similar light-intensity distribution, which has to be recorded in the medium. Namely, an extremely large dynamic range is required for a recording material. Moreover, when a plurality of page data is recorded in one location by, for example, angular multiplexing, the 0th-order beam portion overlaps many times, and thus, the integrated light intensity at the portion becomes too high as compared with that of other portions, and this disables recording, or at worst, this results in something like burn-in. Because the 0th-order beam contains a low-frequency component of the modulation pattern, disabling of recording with the 0th-order beam portion may lead to degradation of a reproduced image.

Conventional technologies to solve the problems as follows are known. First, JP-A 2004-198816 (KOKAI) discloses a method of removing a 0th-order beam by removing a central portion of a Fourier-transformed image or of a Fresnel-transformed image using a specific light-shielding filter. JP-A 2000-66565 (KOKAI) and U.S. Pat. No. 6,317,404 describe a method of shielding against a part of a Fourier-transformed image using a specific light-shielding filter.

JP-A 2005-352097 (KOKAI) discloses a method of reducing a maximum intensity of interference fringes by reducing light in an area of a reference beam, irradiated upon recording, corresponding to a 0th-order beam of an information beam. Further, JP-A 2007-172682 (KOKAI) discloses a method of reducing the intensity of a 0th-order beam by placing a light-reducing filter for the information beam.

JP-A 2005-10585 (KOKAI) discloses a method of placing an optical element to make uniform an intensity distribution of collimated light. Furthermore, a technical literature [Michael J. O'Callaghan, John R. McNeil, Chris Walker, and Mark Handschy, “Spatial light modulators with integrated phase masks for holographic data storage”, in Tech. Digest of ODS 2006, (IEEE 2006), pp. 23-25.] discloses a method of planarizing a light-intensity distribution of a Fourier image using phase masks.

However, these conventional technologies have following problems. The technologies in JP-A 2004-198816 and 2000-66565 (KOKAI), and in U.S. Pat. No. 6,317,404 indicate blocking of part of information, and cannot therefore avoid degradation of a final reproduced image. Moreover, in the technologies in JP-A 2005-352097 and 2007-172682 (KOKAI), because the 0th-order beam which has been reduced and is used for recording is reproduced as it is, degradation of a final reproduced image cannot be avoided. In addition, the technology in JP-A 2005-10585 (KOKAI) does not reduce the light intensity of the 0th-order beam.

The technologies in the technical literatures require highly accurate position adjustment between each unit of division of a phase mask and each pixel of a spatial light modulator, which causes manufacturing costs to increase because the phase mask is comparatively expensive in cost.

### SUMMARY OF THE INVENTION

According to one aspect of the present invention, an optical information recording/reproducing apparatus includes an irradiation optical system of an information beam to an optical information recording medium that can record information as hologram by using interference fringes produced due to interference between the information beam that carries the information and a reference beam; a first light-reducing element that is placed in an optical path of the irradiation optical system of the information beam and reduces light intensity of part of the information beam; a detector that detects a reproduction beam emitted from the optical information recording medium; and a second light-reducing element that is placed in an optical path of the reproduction beam extending from the optical information recording medium to the detector, and that reduces light intensity of the reproduction beam emitted from an area other than an area, in the optical information recording medium, in which information is recorded with the information beam of which light intensity is reduced by the first light-reducing element.

According to another aspect of the present invention, an optical information recording/reproducing apparatus includes a first irradiation optical system of an information beam to an optical information recording medium that can record information as hologram by using interference fringes produced due to interference between the information beam that carries the information and a reference beam; a first light-reducing element that is placed in an optical path of the information beam in the first irradiation optical system, and reduces light intensity of part of the information beam; a detector that detects a reproduction beam emitted from the optical information recording medium; a second irradiation optical system of the reference beam to the optical information recording medium; and a second light-reducing element that is placed in an optical path of the reference beam in the second irradiation optical system, and that reduces light intensity of the reference beam irradiated to an area, in the optical information recording medium, in which information other than information recorded with the information beam of which light intensity is reduced is recorded.

According to still another aspect of the present invention, an optical information recording medium includes an information recording layer that can record information as hologram by using interference fringes produced due to interference between an information beam that carries the information and a reference beam; and a light reducing layer that is laminated on a surface of the information recording layer on a side of emitting a reproduction beam from the information recorded in the information recording layer with part of the information beam of which light intensity is reduced, and that reduces light intensity of the reproduction beam in an area other than an area, in the information recording layer, in which the information is recorded with the part of the information beam of which light intensity is reduced.

According to still another aspect of the present invention, an optical information recording medium includes an information recording layer that can record information as hologram by using interference fringes produced due to interference between an information beam that carries the information and a reference beam; and a light reducing layer that is formed on the information recording layer and reduces light intensity of part of the reproduction beam.

According to still another aspect of the present invention, an optical information reproducing apparatus includes a detector that can record information as hologram by using interference fringes produced due to interference between an information beam that carries the information and a reference beam, and that detects a reproduction beam emitted from an optical information recording medium (110) that records information with part of the information beam of which light intensity is reduced; and a light-reducing element that is placed in an optical path of the reproduction beam extending from the optical information recording medium to the detector, and that reduces light intensity of the reproduction beam emitted from an area other than an area in which information is recorded with the part of the information beam of which light intensity is reduced.

According to still another aspect of the present invention, an optical information reproducing apparatus includes a light-reducing element that is placed in an optical path in which a reproduction beam is irradiated to an optical information recording medium that can record information as hologram by using interference fringes produced due to interference between an information beam that carries the information and a reference beam, and that reduces light intensity of the reference beam irradiated to an area, in the optical information recording medium, in which information other than information recorded with the information beam of which light intensity is reduced is recorded; and a detector that detects the reproduction beam.

### BRIEF DESCRIPTION OF THE DRAWINGS

FIG. 1 is a schematic diagram illustrating an optical system of a holographic-memory recording/reproducing device according to a first embodiment of the present invention;

FIG. 2 is a schematic diagram illustrating a structure of a light-reducing plate that reduces light intensity of an information beam; and

FIG. 3 is a schematic diagram illustrating a structure of a light-reducing plate that reduces light intensity of a reproduction beam;

FIG. 4 is a graph representing a light-intensity distribution of a Fourier image;

FIG. 5 is a flowchart of a feedback control process for position correction of the light-reducing plate;

FIG. 6 is a schematic diagram illustrating a main structure of an optical system according to a modification of the first embodiment;

FIG. 7 is a schematic diagram illustrating a structure of a holographic-memory recording medium containing the light-reducing plate;

FIG. 8 is a schematic diagram illustrating an optical system of a holographic-memory recording/reproducing device according to a second embodiment of the present invention;

FIG. 9 is a schematic diagram illustrating a structure of a holographic-memory recording/reproducing device according to a third embodiment of the present invention;

FIG. 10 is a graph representing a light-intensity distribution of a Fourier image in a wide range;

FIG. 11 is a schematic diagram illustrating an optical system of a holographic-memory recording/reproducing device according to a fourth embodiment of the present invention; and

FIG. 12 is a flowchart of a movement control process for the light-reducing plate.

### DETAILED DESCRIPTION OF THE INVENTION

Exemplary embodiments of the optical information recording/reproducing apparatus, the optical information reproducing apparatus, and the optical information recording medium according to the present invention are explained in detail below with reference to the accompanying drawings.

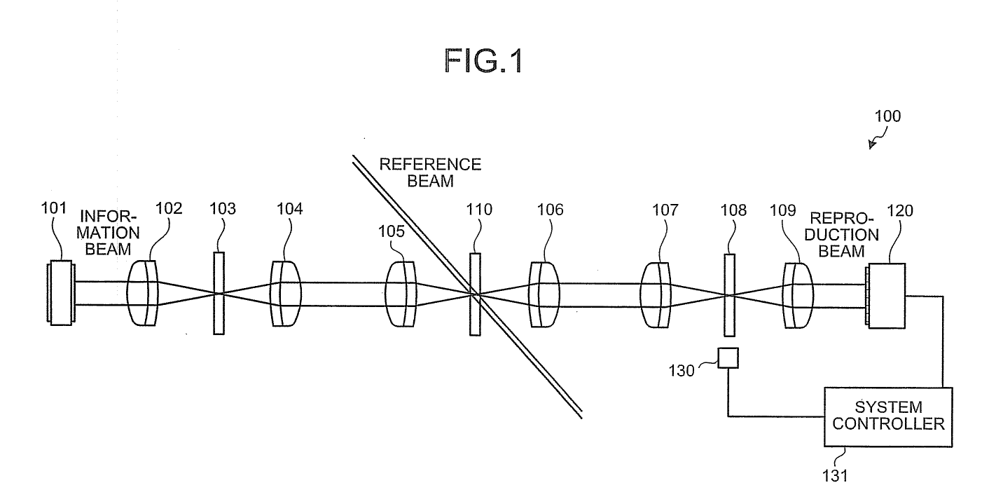

A first embodiment of the present invention employs an optical system of a two-beam interference system in which an information beam and a reference beam are made incident on a holographic-memory recording medium 110 through discrete objective lenses so as to overlap each other in a hologram recording layer of the holographic-memory recording medium 110. However, the optical system is not limited to the two-beam interference system, and thus a collinear system may be employed as the optical system. The collinear system is such that the information beam and the reference beam are made incident on the holographic-memory recording medium 110 from the same direction through one objective lens or the like so as to share the same central axis thereof. In FIG. 1, to avoid complication, the optical system including a light source of the information beam and the reference beam, a wavelength plate, and a polarization beam splitter is not shown, but only an optical path is shown, the optical path including processes from incidence of the information beam and the reference beam on the holographic-memory recording medium 110 to detection of a reproduction beam having passed through the holographic-memory recording medium 110 by an imaging device 120.

In a holographic-memory recording/reproducing device 100 according to the first embodiment, the information beam and the reference beam are emitted from a single laser light source (not shown). The light flux emitted from the laser light source is subjected to shaping, enlargement or reduction by a collimator lens (not shown) as required, and to division by a polarization beam splitter (not shown).

As shown in FIG. 1, in the holographic-memory recording/reproducing device 100, a recording optical system including lenses 102, 104, and 105, and a light-reducing plate 103 are arranged between a spatial light modulator 101 and the holographic-memory recording medium 110.

The reference beam is irradiated to the holographic-memory recording medium 110 as a parallel light flux. When information is to be recorded, the information beam is modulated by the spatial light modulator 101 based on page data to pass through the lenses 102 and 104, is collected by the lens 105, and is irradiated to the holographic-memory recording medium 110.

A liquid crystal element and a digital micromirror device (DMD) or the like can generally be used as the spatial light modulator 101, the element and the device being capable of changing a transmittance, a phase, and a reflection angle for each pixel with an electrical signal.

In the recording optical system, the light-reducing plate 103 is placed between the lenses 102 and 104 near a light collection position (focus position of the lens 102) of the information beam by the lens 102. The light-reducing plate 103 is a light reducing element that reduces the light intensity of part of the information beam. The light-reducing plate 103 will be explained in detail later.

It is noted that the light-reducing plate 103 may be placed at a position slightly displaced from the focus position. In addition, the arrangement of the optical components in the recording optical system is not limited to the above arrangement, and therefore, any other optical component and the like such as a lens and a mirror may be additionally arranged therein.

The holographic-memory recording medium 110 is placed at the focus position of the lens 105. However, the position where the holographic-memory recording medium 110 is placed is not limited to the focus position of the lens 105.

The holographic-memory recording medium 110 is a transmission recording medium, which includes two opposed substrates, and also includes a hologram recording layer held by the two substrates and laminated thereon.

Each of the two substrates is formed of a material having optical transparency such as glass, plastic, polycarbonate, and acrylic resin. However, the material of the substrate is not limited to these materials. For example, the material of the substrate does not need to have the transparency with respect to all wavelengths of a laser beam but only has to have the transparency with respect to a wavelength of a laser beam to be used.

The hologram recording layer is formed of a hologram recording material. The hologram recording material is a material on which a hologram is formed by interference between a laser information beam and a laser reference beam. Photopolymer is generally used as the hologram recording material. The photopolymer is a photosensitive material using photo polymerization of a polymerizable compound (monomer), and generally contains monomer as a main component, a photo-polymerization initiator, and a porous matrix that functions as a role of retaining volume before and after recording. The thickness of the recording material is preferably set to about 100 micrometers or more to acquire diffraction efficiency sufficient for signal reproduction and also acquire angle resolution appropriate for angle multiplexing. The hologram recording material is not limited to these materials. Therefore, any material, such as dichromated gelatin and a photorefractive crystal, capable of recording and reproducing a hologram can be used.

Hologram recording to the hologram recording layer of the holographic-memory recording medium 110 is performed in the following manner. At first, the information beam and the reference beam overlap each other in the hologram recording layer to form interference fringes. At this time, a photo-polymerization initiator in photopolymer absorbs photons to be activated, and activates and accelerates polymerization of monomer in a bright portion of the interference fringes. When the polymerization of the monomer progresses and the monomer in the bright portion of the interference fringes is consumed, the monomer is shifted and supplied from a dark portion of the interference fringes to the bright portion. As a result, a density difference between the bright portion and the dark portion of the interference fringes occurs. Consequently, a refractive index modulation is formed according to an intensity distribution of an interference fringe pattern and the hologram recording is performed.

When information is to be reproduced from the holographic-memory recording medium 110, the information beam is blocked by a shutter or the like, and only the reference beam is made incident on the holographic-memory recording medium 110. At this time, the reproduction beam is emitted from the holographic-memory recording medium 110, passes through lenses 106, 107, and 109 forming a reproduction optical system, and is made incident on the imaging device 120, to acquire a reproduced image by the imaging device 120. A two-dimensional image sensor such as a charge-coupled device (CCD) and a complementary metal oxide semiconductor (CMOS) can be used for the imaging device 120. However, the imaging device is not limited by these, and thus the imaging device 120 can be configured to use a one-dimensional linear image sensor or to use an image pickup tube.

In the reproduction optical system, a light-reducing plate 108 is placed between the lenses 107 and 109 near a light collection position (focus position of the lens 107) of the reproduction beam by the lens 107.

The light-reducing plate 108 is an element that reduces the light intensity of the reproduction beam emitted from an area (a first area) other than an area (a second area), in the hologram recording layer of the holographic-memory recording medium 110, in which information is recorded with the information beam whose light intensity is reduced by the light-reducing plate 103. It is noted that the light-reducing plate 108 may be placed at a position slightly displaced from the focus position if degradation of a reproduced image is negligible. The light-reducing plate 108 will be explained in detail later.

All the lenses 102, 104, and 105 forming the recording optical system and the lenses 106, 107, and 109 forming the reproduction optical system form a so-called 4f system. Specifically, a distance between the spatial light modulator 101 and the lens 102 is equal to a focal length of the lens 102. A distance between the lenses 102 and 104 is equal to a sum of focal lengths of the lenses 102 and 104. A distance between the lenses 104 and 105 is equal to a sum of focal lengths of the lenses 104 and 105. A distance between the lenses 105 and 106 is equal to a sum of focal lengths of the lenses 105 and 106. A distance between the lenses 106 and 107 is equal to a sum of focal lengths of the lenses 106 and 107. A distance between the lenses 107 and 109 is equal to a sum of focal lengths of the lenses 107 and 109. A distance between the lens 109 and the imaging device 120 is equal to the focal length of the lens 109.

The arrangement of the optical components in the reproduction optical system is not limited to the above arrangement, and therefore, any other optical component and the like such as a lens and a mirror may be additionally arranged therein if the light-reducing plate 108 is placed near the light collection position of the reproduction beam.

A drive unit 130 moves the light-reducing plate 108 according to a movement instruction issued from a system controller 131. The drive unit 130 corresponds to a motor, a piezoelectric element, and an electrostatic element, or the like. The system controller 131 determines a positional displacement and a displacement direction between an optical axis of the reproduction beam and the light-reducing plate 108, from the reproduced image detected by the imaging device 120, and issues a movement instruction, to the drive unit 130, in which the positional displacement and a movement direction being an opposite direction to the displacement direction are specified.

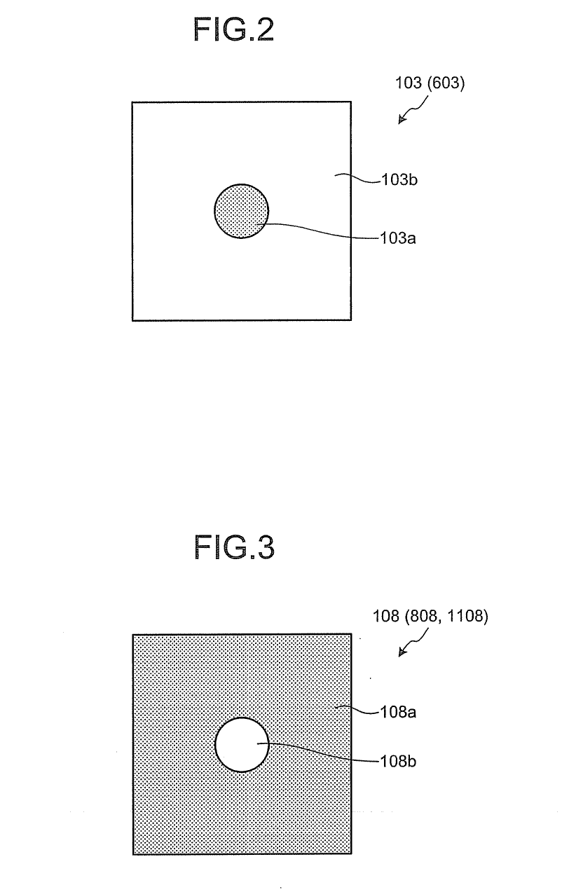

Next, the details of the light-reducing plate 103 are explained below. As shown in FIG. 2, the light-reducing plate 103 has a circular light-reducing filter 103a with a predetermined transmittance to reduce light intensity, placed in an area through which a 0th-order beam as part of the information beam passes, and this allows reduction of the light intensity of the 0th-order beam. An area other than the area through which the 0th-order beam passes is a transmission area 103b through which the information beam passes as it is without reducing the light intensity of the information beam. The transmittance mentioned here represents a ratio of light intensity of a light flux, of an incident light flux, which passes through the transmission area 103b to light intensity of the incident light flux. When the light fully passes therethrough, the transmittance is 1, while when the light is fully blocked, then the transmittance is 0.

If it is necessary to place an optical aperture at a position of the light-reducing plate 103 to remove a high-order beam, an area around the light-reducing plate 103 can be formed as a light-shielding area so that the light-reducing plate 103 can also be used as the optical aperture. A diameter of the light-reducing filter 103a of the light reducing plate 103 is preferably larger than a diameter of at least the 0th-order beam of the information beam. However, if the diameter is too large, the light intensity of the beam in the area where the light intensity does not need to be reduced is also excessively reduced, and this may cause degradation of a reproduced image or increase in noise. Therefore, the diameter of the light-reducing filter 103a is preferably determined in terms of a light-intensity distribution around the light-reducing filter 103a, a transmittance of the light-reducing filter, or fitting accuracy.

The transmittance of the light-reducing filter 103a is preferably equal to a ratio between the light intensity at the center of the 0th-order beam and the maximum light intensity of the transmission area 103b. This configuration enables the light-intensity distribution to be averaged while minimizing the increase in noise.

However, if a plurality of multiple recording is performed on one location using an angular multiplexing recording system, it may sometimes be preferred to further reduce the transmittance. More specifically, in the area other than the 0th-order beam, the light-intensity distribution is changed or is displaced for each recording according to switching of page data or according to a change of a relative angle between the information beam and the holographic-memory recording medium 110, and integrated light-intensity distributions thereby become sometimes comparatively uniform. However, because the 0th-order beam portion is difficult to be changed or displaced, even if the portions are integrated, the peak is difficult to decrease.

In this case, the transmittance of the light-reducing filter 103a is not made nearly equal to the ratio between the light intensity at the center of the 0th-order beam and the maximum light intensity of the transmission area 103b unlike the above explanation, but the transmittance of the light-reducing filter 103a is preferably made equal to a ratio between the light intensity at the center of the 0th-order beam and the maximum light intensity after being averaged of the transmission area 103b.

As for the maximum light intensity after being averaged, the level of light intensity averaged in integration upon multiple recording should be considered. Setting of the transmittance to 0 (zero) or of complete light shielding causes part of the information beam to be blocked and this results in degradation of a final reproduced image. Therefore, the setting is desirably avoided.

As shown in FIG. 3, the light-reducing plate 108 includes a circular transmission area 108b (a second area) through which the light flux, of the reproduction beam, whose light intensity is reduced by the light-reducing filter 103a of the light-reducing plate 103 passes, and also includes a light-reducing filter 108a (a first area) which is the area other than the transmission area 108b (a second area) and has nearly the same transmittance as that of the light-reducing filter 103a. In other words, the filter pattern of the light-reducing plate 103 and the filter pattern of the light-reducing plate 108 have a complementary relationship if they are mutually inverted.

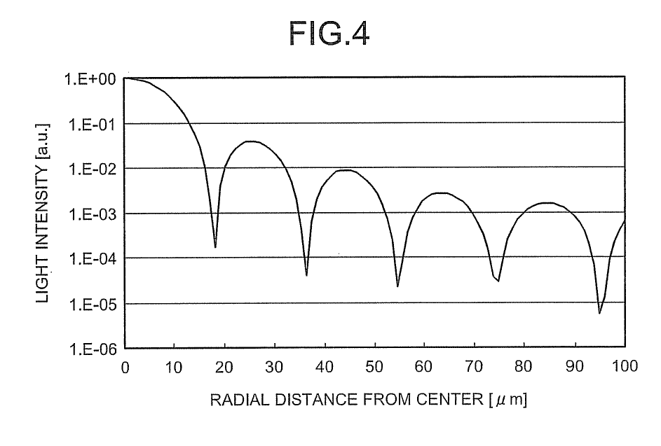

In general, of the information beam, the light intensity of the 0th-order beam is 10 times to 1000 times, or more, higher than the light intensity of the light flux of ±1st-order beams or the like other than the 0th-order beam. Consequently, a similar light-intensity distribution also occurs in interference fringes recorded in the hologram recording layer, and this distribution has to be recorded in the holographic-memory recording medium 110. FIG. 4 is a graph representing a light-intensity distribution of a Fourier image when a pixel pitch of the spatial light modulator 101 is 13.68 micrometers, a focal length of the lens is 80 millimeters, and a diameter of page data is 325 pixels. In FIG. 4, the horizontal-axis indicates a radial distance from the center of the holographic-memory recording medium 110, and the vertical-axis indicates light intensity.

As shown in FIG. 4, it is understood that the light intensity in a radial range of about 10 micrometers from the center is about 10 times higher than that of the peripheral area and is 1000 times, or more, higher than the light-intensity distribution in a radial range of 100 micrometers from the center. Namely, a very large dynamic range is required for the recording material. Further, for example, when a plurality of page data is to be recorded in one location by angular multiplexing recording, the portion of the 0th-order beam overlaps many times. Thus, integrated light intensity in this portion becomes too high as compared with that of other portions, and this disables recording, or at worst, this results in something like burn-in. Because the 0th-order beam contains a low-frequency component of a modulation pattern, disabling of recording with the 0th-order beam portion leads to degradation of a reproduced image. In the first embodiment, therefore, the light-reducing plate 103 is placed in the recording optical system to reduce the light intensity of the 0th-order beam of the information beam.

Meanwhile, as explained above, the light intensity of the 0th-order beam of the information beam is reduced and recording in the hologram recording layer is performed with this beam, which results in recording without using part of the information beam, which inevitably causes degradation of a reproduced image. In the first embodiment, therefore, the light-reducing plate 108, which has the inverted filter pattern of the light-reducing plate 103 to have a mutual complementary relationship with the light-reducing plate 103, is further placed in the reproduction optical system, and the degradation of the reproduced image is thereby avoided.

The size of the transmission area 108b of the light-reducing plate 108 is determined based on the size of the light-reducing filter 103a of the light-reducing plate 103 and based on the magnification decided by the lenses 104, 105, 106, and 107. Specifically, in the configuration of the optical system as shown in FIG. 1, when DA is a diameter of the circular light-reducing filter 103a of the light-reducing plate 103, DB is a diameter of the circular transmission area 108b of the light-reducing plate 108, and focal lengths of the lenses 104, 105, 106, and 107 are f2 to f5, respectively, a relationship between DA and DB can be represented by the following Equation (1).

DB=(f3/f2)×(f5/f4)×DA (1)

As shown in FIG. 1, the first embodiment is configured to place the light-reducing plate 108 irrespective of recording or reproducing of information in or from the holographic-memory recording medium 110. However, when a transmitted image having transmitted through the holographic-memory recording medium 110 does not need to be acquired upon recording of information in the holographic-memory recording medium 110, there is no need to place the light-reducing plate 108 when the information is recorded. Therefore, it may be configured to move the light-reducing plate 108 into the optical path of the reproduction beam only when the information in the holographic-memory recording medium 110 is reproduced.

In the first embodiment, the transmittance of the light-reducing filter 103a of the light-reducing plate 103 is set to be nearly the same as that of the light-reducing filter 108a of the light-reducing plate 108, however, it is not limited thereto. For example, if degradation of the reproduced image is negligible, the transmittance of the light-reducing filter 103a and the transmittance of the light-reducing filter 108a may be set differently from each other.

In the first embodiment, both the shape of the light-reducing filter 103a and that of the transmission area 108b are circular, however, the shape is not limited thereto, and thus, they may be formed in any shape. It should be noted that if the shape is circular, there are such advantages that there is little increase in noise and no angle adjustment is needed when the light-reducing plates 103 and 108 are fitted.

There is no need to form a sharp boundary between the light-reducing filter 103a or 108a and the transmission area 103b or 108b, and thus, it may be structured so that the transmittance changes little by little in gradation therebetween. In this case, a margin for displacement can be relaxed.

Each whole size of the light-reducing plates 103 and 108 is preferably a size that covers an entire light flux that passes through the lenses 102 and 107.

A so-called neutral density (ND) filter or a dielectric multilayer can be used as the light-reducing filters 103a and 108a. The ND filter is used to disperse a light absorbing material, or to absorb or reflect beams in or by a metal layer coated so as to have an appropriate thickness. Moreover, any element, using a liquid crystal element or an electrochromic material, capable of changing the transmittance with an electrical signal can be used as the light-reducing filters 103a and 108a. By using the liquid crystal element divided into multiple regions and the electrochromic material as the light-reducing filters 103a and 108a, there is an advantage that only electrical switching to change an area with a different transmittance allows coincidence of each center of the light-reducing filter 103a and the transmission area 108b with the center of the optical axis, so that there is no need to move the light-reducing plate 108.

The electrochromic material is a material that can electrically switch between coloring and decoloring using an electrochemical reaction and that is used for a light control glass and a display element in a combination thereof with an electrolyte. A typical electrochromic material as an inorganic system is a combination of tungsten oxide (WO₃) with cation (H ion, Li ion, Na ion, or Zn ion) in the electrolyte. However, it is understood that instead of tungsten, other transition metals (titanium, vanadium, chromium, manganese, ion, cobalt, nickel, copper, zirconium, niobium, molybdenum, ruthenium, rhodium, rhenium, osmium, and iridium, or the like), indium, tin, praseodymium, samarium, dysprosium, holmium, erbium, and lutetium also represent electrochromic characteristics.

Other examples of the electrochromic material include a lutecium-diphthalocyanine complex, a cobalt-pyridinoporphyrazine complex, and Prussian blue (Fe₄(FeCN₆)₃). An organic system includes rare-earth diphthalocyanine, dye-pendant type polymer (e.g., TFT polymer and pyrazoline polymer), a polymer complex (e.g., viologen polymer), polymer produced by electrolytic polymerization (e.g., polythiophene, polypyrrole, and polyaniline), viologen derivative (e.g., heptyl viologen), a bipyridine complex (e.g., cobalt bipyridine), organic dye (e.g., quinone system, styryl series, pyrazoline series, fluorene series, diphenyl amine series, and verdazyl), or Baytron P by H. C. Starck in U.S.

The electrolyte can be classified into liquid, semisolid (high polymer), and solid, however, solid is most desirable in terms of stability and responsiveness. The solid can be derivatives containing H ion as a mobile ion (e.g., MgF₂, CaF₂, SiO, ZrO₂, Ta₂O₅₅Cr₂O₃, and LiF), and solid electrolytes containing Na ion, Li ion, Ag ion, or the like, as mobile ions (e.g., Na-β-Al₂O₃, NaI+xZr₂SixP₃-xO₁₂, LiN, LiI, Li₂WO₄, and RbAg₄I₅).

As explained above, in the first embodiment, the reasons why the light-reducing plate 103 is placed in the recording optical system and why the light-reducing plate 108 is placed in the reproduction optical system will be explained below.

It is preferable that the center of the light-reducing filter 103a of the light-reducing plate 103 and the center of the transmission area 108b of the light-reducing plate 108 coincide with the center of the optical axis and that there is no displacement between both areas when observed from the imaging device 120. With this structure, the area where the light intensity is reduced by the light-reducing plate 103 does not overlap with the area where the light intensity is reduced by the light-reducing plate 108, and this results in recovery of the entire light-intensity distribution to its original distribution, so that the reproduced image can be observed by the imaging device 120 without degradation of the image.

It is noted that the displacement is acceptable if the degradation of the reproduced image observed by the imaging device 120 is negligible.

There is a case in which the optical axis of the reproduction beam reproduced from the holographic-memory recording medium 110 may be displaced in association with displacement of positions and angles of the holographic-memory recording medium 110 and the reference beam when the information is to be reproduced. In the first embodiment, the feedback control is provided by the system controller 131 and the drive unit 130 so as to move the light-reducing plate 108 following the positional displacement and the angular displacement of the optical axis of the reproduction beam, so that a relative positional displacement between the optical axis of the reproduction beam and the light-reducing plate 108 is corrected, and the degradation of the reproduced image is thereby prevented.

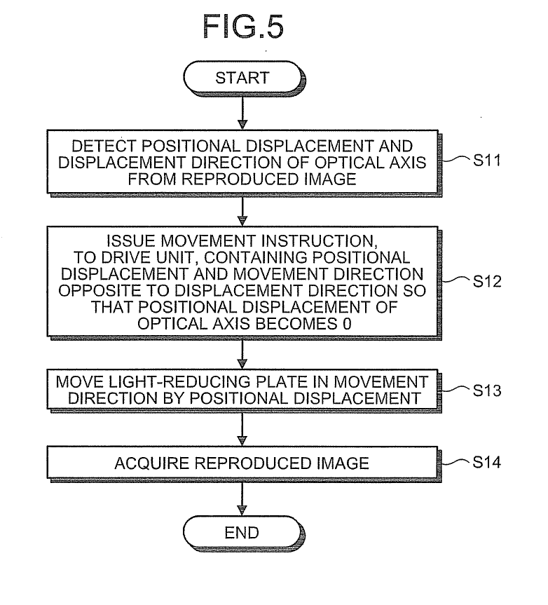

The procedure of a feedback control process for position correction of the light-reducing plate 108 according to the first embodiment will be explained below with reference to FIG. 5. When there occurs an angular or a positional displacement of the holographic-memory recording medium 110 or of the reference beam, the system controller 131 detects a positional displacement and a displacement direction of the optical axis of the reproduction beam based on the reproduced image obtained from the imaging device 120 (Step S11). Next, the system controller 131 issues a movement instruction, to the drive unit 130, containing the positional displacement and a movement direction opposite to the displacement direction so that the positional displacement of the optical axis of the reproduction beam becomes 0 (Step S12). The drive unit 130 receives the movement instruction and moves the light-reducing plate 108 in the movement direction by the positional displacement according to the movement instruction (Step S13). Then, the reproduced image is acquired by the imaging device 120 (Step S14). By performing the feedback control, the degradation of the reproduced image can be reduced even if the optical axis of the reproduction beam is displaced in association with the positional and the angular displacements of the holographic-memory recording medium 110 and of the reference beam.

Placed in the reproduction optical system of the holographic-memory recording/reproducing device 100 is the light-reducing plate 108 that includes the transmission area 108b through which the light flux, of the reproduction beam, whose light intensity is reduced by the light-reducing filter 103a of the light-reducing plate 103 passes, and that also includes the light-reducing filter 108a which is the area other than the transmission area 108b and has nearly the same transmittance as that of the light-reducing filter 103a. Therefore, it is possible to easily prevent, at low cost, the degradation of the reproduced image of the holographic-memory recording medium 110 in which the information is recorded with the 0th-order beam of the information beam whose light intensity is reduced.

The light-reducing plate that reduces the light intensity of the 0th-order beam of the information beam may be placed between the recording optical system and the holographic-memory recording medium 110, or placed at a position immediately upstream of an information-beam incident plane of the holographic-memory recording medium 110.

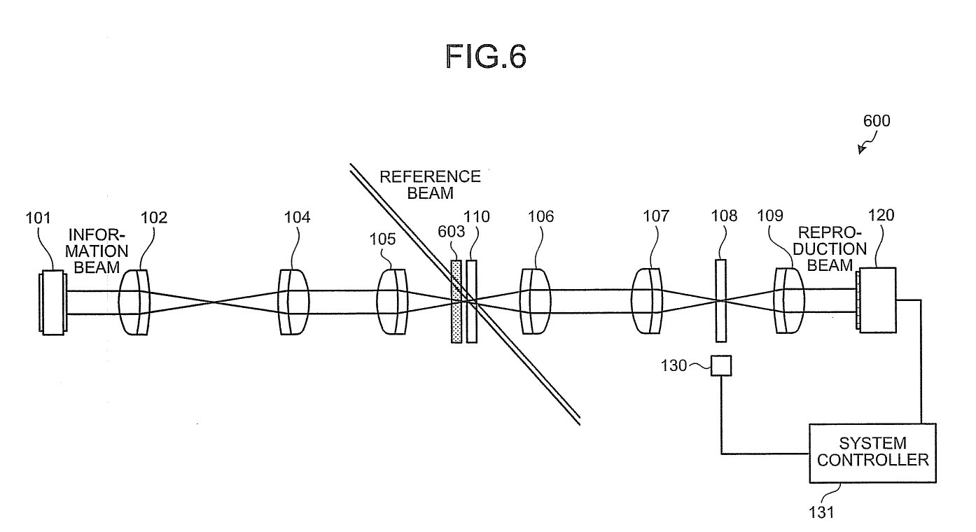

As shown in FIG. 6, in a holographic-memory recording/reproducing device 600 according to a modification of the first embodiment, a light-reducing plate 603 that reduces the light intensity of the 0th-order beam of the information beam is placed between the lens 105 and the holographic-memory recording medium 110 at a position immediately upstream of the information-beam incident plane of the holographic-memory recording medium 110. In FIG. 6, the rest of the configuration other than the placement of the light-reducing plate 603 is the same as the optical system according to the first embodiment as shown in FIG. 1.

As shown in FIG. 6, the information beam modulated by the spatial light modulator 101 is collected by the lens 105 and is made incident on the holographic-memory recording medium 110. Here, the lenses 102 and 104 do not have to be provided in the configuration. The light-reducing plate 603 is placed at a focus position of the lens 105, and the holographic-memory recording medium 110 is placed at a position immediately downstream of the light-reducing plate 603. These positions do not have to be accurate near the focus position if the degradation of the reproduced image is negligible, however, these positions need to be arranged so that the information beam having passed through the light-reducing plate 603 is made incident on the holographic-memory recording medium 110.

The light-reducing plate 603 prevents the reference beam from entering the medium. Namely, the light-reducing filter of the light-reducing plate needs to be designed so as not to interfere with the reference beam. Therefore, when the light-reducing filter is placed without interference with the reference beam in the above manner and the recording/reproduction of information in/from the hologram recording layer is not so negatively affected, the light-reducing plate that reduces the light intensity of the 0th-order beam of the information beam may be provided inside the holographic-memory recording medium.

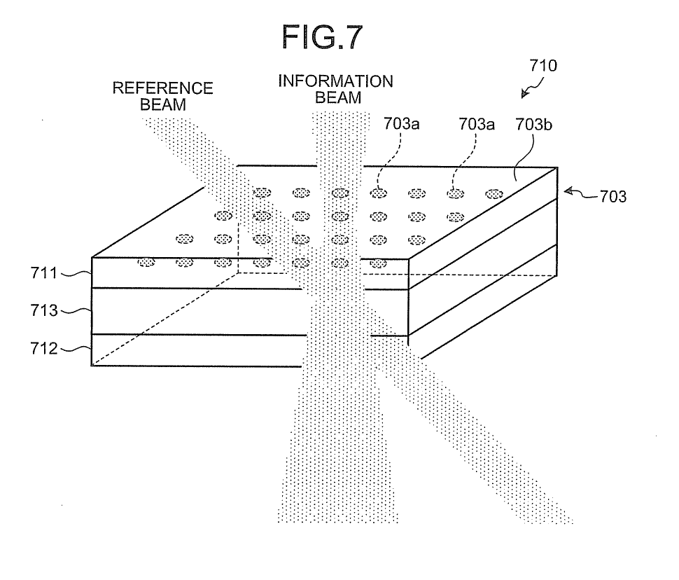

In the modification, as shown in FIG. 7, a holographic-memory recording medium 710 according to the modification of the first embodiment is a transmission recording medium, which includes two opposed substrates 711 and 712, and also includes a hologram recording layer 713 held by the two substrates 711 and 712 and laminated thereon. A light-reducing plate 703 is provided in the substrate 711 on the information-beam incident side of the holographic-memory recording medium 710. Formed in the light-reducing plate 703 are a plurality of circular light-reducing filters 703a which are spotted therein and a transmission area 703b around the light-reducing filters 703a. The structure of the light-reducing filter 703a and the transmission area 703b is the same as the light-reducing plate 103 according to the first embodiment. The 0th-order beam of the information beam is irradiated so that the 0th-order beam passes through one of the light-reducing filters 703a, and the reference beam is made incident on the medium so as not to be irradiated to the light-reducing filter 703a.

The structures and the materials of the substrates 711 and 712 and the hologram recording layer 713 are the same as these of the holographic-memory recording medium 110 according to the first embodiment. By using the holographic-memory recording medium 710 structured in the above manner, it is possible to easily prevent, at low cost, the degradation of the reproduced image of the optical-information recording medium in which information is recoded with the 0th-order beam of the information beam whose light intensity is reduced.

In the first embodiment, the light-reducing plate 108 that reduces the light intensity of the reproduction beam emitted from the area other than the area, in which the information is recorded with the information beam whose light intensity is reduced, is placed in the reproduction optical system. However, in a second embodiment of the present invention, a light-reducing plate is placed between the holographic-memory recording medium 110 and the reproduction optical system.

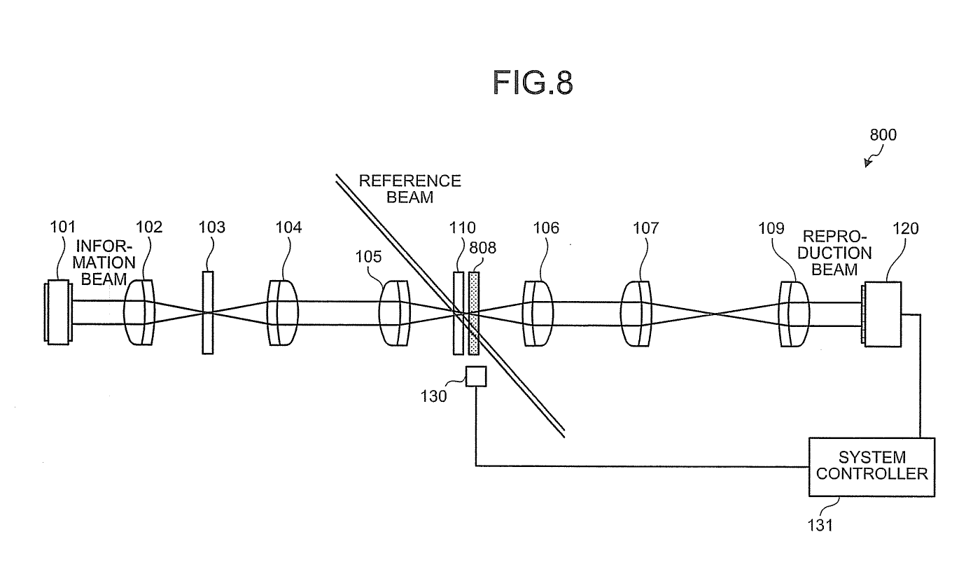

As shown in FIG. 8, a holographic-memory recording/reproducing device 800 according to the second embodiment includes a light-reducing plate 808 that reduces the light intensity of a reproduction beam emitted from an area other than an area in which information is recorded with the 0th-order beam whose light intensity is reduced by the light-reducing plate 103. The light-reducing plate 808 is placed at a position immediately downstream of a reproduction-beam emitted plane of the holographic-memory recording medium 110 or at a position upstream of a reproduction-beam incident plane of the lens 106 being the reproduction optical system, and placed at the focus position of the lens 106. The structure of the light-reducing plate 808 and the rest of the configuration are the same as these of the first embodiment.

In the second embodiment, the reproduction beam emitted from the holographic-memory recording medium 110 first passes through the light-reducing plate 808, and this passage allows reduction in the light intensity of the reproduction beam emitted from the area other than the area in which the information is recorded with the 0th-order beam whose light intensity is reduced. The reproduction beam sequentially enters the lenses 106, 107, and 109, and then it is detected as the reproduced image by the imaging device 120. In the second embodiment, the light-reducing plate 808 is placed at a position immediately downstream of the holographic-memory recording medium 110, and, therefore, the lenses 107 and 109 do not have to be provided.

Moreover, the light-reducing plate 808 does not have to be accurately placed near the focus position of the lens 106 if the degradation of the reproduced image is negligible. However, the light-reducing plate 808 needs to be placed so that the reproduction beam emitted from the holographic-memory recording medium 110 is made incident on the light-reducing plate 808. Meanwhile, the reference beam is not involved in reproduction after passing through the holographic-memory recording medium 110, and thus, the light-reducing plate 808 may be placed at a position where the light-reducing plate 808 and the reference beam interfere with each other.

Placed between the holographic-memory recording medium 110 and the reproduction optical system of the holographic-memory recording/reproducing device 800 according to the second embodiment is the light-reducing plate 808 that includes the transmission area 108b through which the light flux, of the reproduction beam, whose light intensity is reduced by the light-reducing filter 103a of the light-reducing plate 103 passes, and that also includes the light-reducing filter 108a which is the area other than the transmission area 108b and has nearly the same transmittance as that of the light-reducing filter 103a. Therefore, it is possible to easily prevent, at low cost, the degradation of the reproduced image of the holographic-memory recording medium 110 in which the information is recorded with the 0th-order beam of the information beam whose light intensity is reduced.

Placed in the optical path of the reproduction beam according to the first or the second embodiment is the light-reducing plate that includes the transmission area 108b through which the light flux, of the reproduction beam, whose light intensity is reduced by the light-reducing filter 103a of the light-reducing plate 103 passes, and that also includes the light-reducing filter 108a which is the area other than the transmission area 108b and has nearly the same transmittance as that of the light-reducing filter 103a. However, in a third embodiment of the present invention, the light-reducing plate is internally provided in the holographic-memory recording medium.

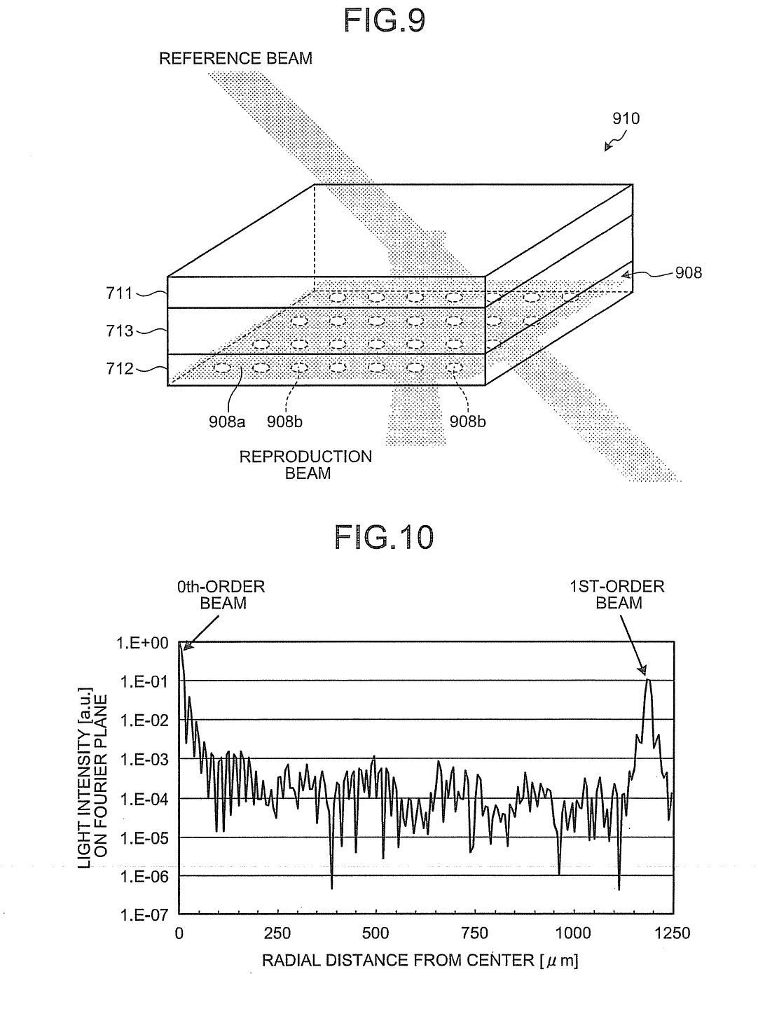

As shown in FIG. 9, a holographic-memory recording medium 910 according to the third embodiment is a transmission recording medium, which includes the two opposed substrates 711 and 712, and also includes the hologram recording layer 713 held by the two substrates 711 and 712 and laminated thereon. A light-reducing plate 908 is provided inside the substrate 712 on the reproduction beam emission side. Formed in the light-reducing plate 908 are a plurality of circular transmission areas 908b (a second area) which are spotted therein and a light-reducing filter 908a (a first area) around the transmission areas 908b. The structure of the light-reducing filter 908a and the transmission area 908b is the same as the light-reducing plate 108 according to the first embodiment.

Therefore, a light flux portion, of the reproduction beam, emitted from the information recorded with the information beam whose light intensity is reduced by the light-reducing filter 103a of the light-reducing plate 103 passes through one of the transmission areas 908b. The rest of the structure is the same as that of the first embodiment.

In the third embodiment, the light-reducing plate 908 is provided in the substrate 712 so that the reproduction beam emitted from the hologram recording layer 713 of the holographic-memory recording medium 910 enters the light-reducing plate 908. Meanwhile, the reference beam is not involved in reproduction after passing through the holographic-memory recording medium 910, and thus, if the light-reducing plate 908 is provided in the substrate 712, the light-reducing plate 908 may be placed at even a position where the reference beam interferes therewith.

Placed in the substrate 712 of the holographic-memory recording medium 910 according to the third embodiment is the light-reducing plate 908 that reduces the light intensity of the reproduction beam emitted from the area other than the area in which the information is recorded with the information beam whose light intensity is reduced by the light-reducing plate 103. Therefore, it is possible to easily prevent, at low cost, the degradation of the reproduced image of the holographic-memory recording medium 910 in which the information is recorded with the 0th-order beam of the information beam whose light intensity is reduced.

Moreover, because the light-reducing plate 908 is internally provided in the holographic-memory recording medium 910, even if the positions and the angles of the holographic-memory recording medium 910 and the reference beam are displaced, no displacement occurs between the light-reducing plate 908 and the optical axis of the reproduction beam. Consequently, there is no need to place the drive unit 130 and to provide the feedback control for correction of positional displacement unlike the first embodiment, which allows the configuration of the holographic-memory recording/reproducing device to be simplified.

In the first to the third embodiments, any one of the light-reducing plates according to the first embodiment, the modification of the first embodiment, and the second embodiment (light-reducing plates 103, 603, and 703) can be used. However, both any one of the light-reducing plates 103, 603, and 703 and any one of the light-reducing plates 108, 808, and 908 cannot be set as focus positions, and thus, the degradation of the reproduced image is sometimes necessary to be accepted.

If the maximum light intensity not only of the 0th-order beam of the information beam but also of the high-order beam such as ±1st-order beams and ±secondary beams is desired to be reduced using the light-reducing plates 103, 603, and 703, the light-reducing plates 103 and 603 only have to be structured to have the light-reducing filters in which filter patterns are formed so as to coincide with positions of the beams respectively. It is noted that the transmittance is preferably an adjusted one according to a ratio between the maximum light intensity of the 0th-order beam and the maximum light intensity of the ±1st-order beams or the like, in terms of preventing a noise increase.

FIG. 10 represents a wider range of a light-intensity distribution in the same condition as that of the light-intensity distribution as shown in FIG. 4. However, an intensity ratio between the 0th-order beam and the 1st-order beam is about 10:1, and therefore a ratio between the transmittances of the light-reducing filter corresponding to the intensity ratio is preferably equivalent to about 10:1. Specifically, if a maximum light intensity ratio between the 0th-order beam and the 1st-order beam is 10:1 and a transmittance of the 0th-order beam portion of the light-reducing plate 103 is 0.01, then it is preferable that the transmittance of the 1st-order beam portion is 0.1 which is 10 times higher than that of the 0th-order beam portion.

Furthermore, the light-reducing filters and the transmission areas in the light-reducing plates 103, 603, and 703 and the light-reducing plates 108, 808, and 908 are formed so that each transmittance pattern smoothly changes over the entire plane according to the light-intensity distribution as shown in FIG. 10, and thus, recording with more averaged light-intensity distribution can be performed.

As for the maximum light intensity of the 1st-order beam, if the light-intensity distribution in the area other than the area of the 0th-order beam is integrated by multiple recording and is averaged, the maximum light intensity of integrated light-intensity distribution in the area corresponding to the 1st-order beam after being averaged has to be handled as the maximum light intensity of the 1st-order beam.

In the holographic-memory recording/reproducing devices according to the first and the second embodiments, the degradation of the reproduced image is prevented using the light-reducing plate that reduces the light intensity of the reproduction beam emitted from the area other than the area in which the information is recorded with the information beam whose light intensity is reduced. However, a holographic-memory recording/reproducing device 1100 according to a fourth embodiment of the present invention is configured to place the light-reducing plate in an optical path in which the reference beam is irradiated to the holographic-memory recording medium.

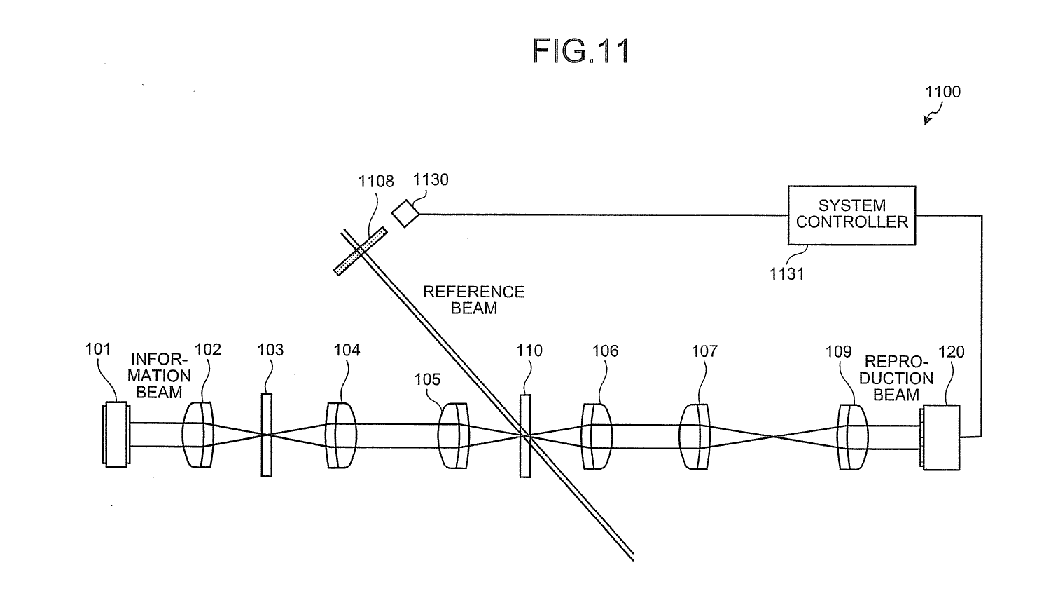

As shown in FIG. 11, the fourth embodiment is different from the first embodiment in a point that a light-reducing plate 1108 that reduces the light intensity of the reproduction beam emitted from an area (a first area) other than the area (a second area), in which the information is recorded with the information beam whose light intensity is reduced, is placed not in the reproduction optical system extending from the holographic-memory recording medium 110 to the imaging device 120, but in the optical path of the reference beam up to the holographic-memory recording medium 110. However, the rest of the structure is the same as that of the first embodiment. The light-reducing plate 1108 has the same structure as that of the light-reducing plate 108 according to the first embodiment, that is, the light-reducing plate 1108 has the light-reducing filter 108a and the transmission area 108b.

In the fourth embodiment, when information is to be reproduced from the holographic-memory recording medium 110, the reference beam to be irradiated to the holographic-memory recording medium 110 passes through the transmission area 108b of the light-reducing plate 1108. Consequently, the light intensity of the reference beam in an area, corresponding to the area in which the light intensity of the 0th-order beam of the information beam is reduced by the light-reducing plate 103, is thereby increased and the reference beam with the increased light intensity is irradiated to the holographic-memory recording medium 110. Moreover, the reference beam passes through the light-reducing filter 108a of the light-reducing plate 1108, and the light intensity of the reference beam in an area corresponding to the area other than the area in which the light intensity of the 0th-order beam of the information beam is reduced by the light-reducing plate 103, is thereby reduced and the reference beam with the reduced light intensity is irradiated to the holographic-memory recording medium 110.

The light-reducing plate 1108 is used only when the information is to be reproduced from the holographic-memory recording medium 110 but not used when the information is to be recorded in the holographic-memory recording medium 110. Consequently, a system controller 1131 according to the fourth embodiment determines whether the information is recorded or reproduced in or from the holographic-memory recording medium 110. When it is determined that the information is to be recorded, the system controller 1131 issues an instruction to move the light-reducing plate 1108 to a position outside the optical path of the reference beam, to a drive unit 1130. Meanwhile, when it is determined that the information is to be reproduced, the system controller 1131 issues an instruction to the drive unit 1130 to move the light-reducing plate 1108 to a position in the optical path of the reference beam. The drive unit 1130 receives the instruction from the system controller 1131, to move the light-reducing plate 1108 into the optical path of the reference beam or to move it to the position outside the optical path of the reference beam.

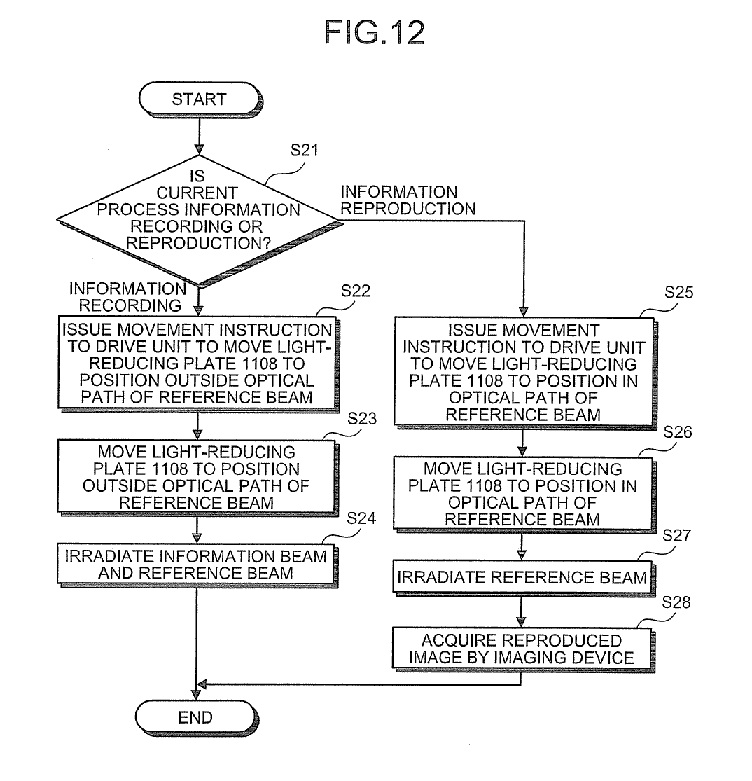

Next, the procedure of a movement control process for the light-reducing plate 1108 will be explained below with reference to FIG. 12. First, the system controller 1131 determines, from an instruction by a user, whether a current process is a process for information recording in the holographic-memory recording medium 110 or is a process for information reproduction from the holographic-memory recording medium 110 (Step S21). When it is determined that the current process is the process for information recording, the system controller 1131 issues a movement instruction to the drive unit 1130 to move the light-reducing plate 1108 to a position outside the optical path of the reference beam (Step S22). The drive unit 1130 receives the movement instruction and moves the light-reducing plate 1108 to the position outside the optical path (Step S23). Then, the system controller 1131 controls so as to irradiate the information beam and the reference beam from a laser light source (not shown) to the holographic-memory recording medium 110 (Step S24).

Accordingly, the information beam that has passed through the light-reducing plate 103 and the 0th-order beam thereof is thereby reduced is irradiated to the holographic-memory recording medium 110, while the reference beam is irradiated to the holographic-memory recording medium 110 without passing through the light-reducing plate 1108. Consequently, the information beam with the reduced light intensity of the 0th-order beam interferes with the reference beam, and the information is recorded in the hologram recording layer.

On the other hand, at Step S21, when it is determined that the current process is the process for information reproduction, the system controller 1131 issues a movement instruction to the drive unit 1130 to move the light-reducing plate 1108 to a position in the optical path of the reference beam (Step S25). The drive unit 1130 receives the movement instruction and moves the light-reducing plate 1108 to the position in the optical path of the reference beam (Step S26). Then, the system controller 1131 controls so as to irradiate the reference beam from the laser light source (not shown) to the holographic-memory recording medium 110 (Step S27). The reproduced image is acquired by the imaging device 120 (Step S28).

Accordingly, upon information reproduction, the reference beam passes through the light-reducing filter 108a of the light-reducing plate 1108. Therefore, the reference beam whose light intensity is reduced is irradiated to information in the area other than the area in which information is recoded with the 0th-order beam of the information beam whose light intensity is reduced by the light-reducing plate 103. This feature complements the distribution in which the information is recorded with only the 0th-order beam of the information beam whose light intensity is reduced upon information recording in the holographic-memory recording medium 110, to enable recovery of the light-intensity distribution for the reproduction beam.

As explained above, in the holographic-memory recording/reproducing device 1100 according to the fourth embodiment, the light-reducing plate 1108 that reduces the light intensity of the reproduction beam emitted from the area other than the area in which the information is recorded with the information beam whose light intensity is reduced is placed in the optical path in which the reference beam is irradiated to the holographic-memory recording medium 110. Thus, it is possible to easily prevent, at low cost, the degradation of the reproduced image of the holographic-memory recording medium 110 in which the information is recorded with the 0th-order beam of the information beam whose light intensity is reduced.

Moreover, in the fourth embodiment, because the light-reducing plate 1108 is placed in the optical path of the reference beam, even if the positions and the angles of the holographic-memory recording medium 110 and the reference beam are displaced, no displacement occurs between the light-reducing plate 1108 and the optical axis of the reference beam. Consequently, there is no need to provide the feedback control for correction of positional displacement unlike the first embodiment, which allows the configuration of the holographic-memory recording/reproducing device to be simplified.

In the fourth embodiment, the control is provided so that the light-reducing plate 1108 is removed from the optical path of the reference beam upon information recording and the light-reducing plate 1108 is moved into the optical path thereof upon information reproduction. However, if the light-reducing plate 1108 is not used for information recording, this configuration is not limited to the above case. For example, the control can also be provided so that the optical path itself of the reference beam is changed in such a manner that the position of the light-reducing plate 1108 is fixed, and when the information is to be recorded, the reference beam is irradiated to the holographic-memory recording medium 110 in the optical path in which the reference beam does not pass through the light-reducing plate 1108, while when the information is to be reproduced, the reference beam is irradiated to the holographic-memory recording medium 110 in the optical path in which the reference beam passes through the light-reducing plate 1108. Furthermore, the light-reducing plate 1108 is formed using the liquid crystal element, the electrochromic material, or the like, so that the transmittance can be electrically switched. Specifically, upon information recording, the transmittance of the light-reducing filter 108a is set to 1, and upon information reproduction, the transmittance can be electrically switched to a smaller value than 1.

When an angle and a location of the reference beam change, for example, when an incident angle of the reference beam to the holographic-memory recording medium 110 is changed to reproduce information from the holographic-memory recording medium 110 in which the information is recorded using angular multiplexing recording, it is preferable that the position of the light-reducing plate 1108 is also moved following the change and adjustment is provided so that the central axis of the reference beam coincides with the center of the transmission area 108b of the light-reducing plate 1108. However, adjustment is not limited to the above case if the degradation of the reproduced image is negligible.

The fourth embodiment shows the example where the present invention is applied to the holographic-memory recording/reproducing device. However, advantageous effects of the present invention can be achieved by providing the light-reducing plate 1108 in the optical path of the reference beam. Thus, the present invention can be also applied to a holographic-memory reproducing device that reproduces information from the holographic-memory recording medium. In this case, the optical components (101, 102, 103, 104, and 105) of the recording optical system are simply removed from the configuration in FIG. 11.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical information recording/reproducing apparatus comprising:
an irradiation optical system of an information beam to an optical information recording medium that can record information as hologram by using interference fringes produced due to interference between the information beam that carries the information and a reference beam;
a first light-reducing element that is placed in an optical path of the irradiation optical system of the information beam and reduces light intensity of part of the information beam;
a detector that detects a reproduction beam emitted from the optical information recording medium; and
a second light-reducing element that is placed in an optical path of the reproduction beam extending from the optical information recording medium to the detector, and that reduces light intensity of the reproduction beam emitted from a first area other than a second area, in the optical information recording medium, in which information is recorded with the information beam of which light intensity is reduced by the first light-reducing element.

2. The apparatus according to claim 1, further comprising:
a drive unit that moves a position of the second light-reducing element with respect to an optical axis; and
a correction unit that detects a displacement between the second light-reducing element and the optical axis based on the reproduction beam detected by the detector, and corrects the displacement by driving the drive unit when the displacement occurs.

3. The apparatus according to claim 1, wherein
the first light-reducing element reduces the light intensity of a 0th-order beam of the information beam, and
the second light-reducing element reduces the light intensity of the reproduction beam of information recoded with the information beam other than the 0th-order beam.

4. An optical information recording/reproducing apparatus comprising:
a first irradiation optical system of an information beam to an optical information recording medium that can record information as hologram by using interference fringes produced due to interference between the information beam that carries the information and a reference beam;
a first light-reducing element that is placed in an optical path of the information beam in the first irradiation optical system, and reduces light intensity of part of the information beam;
a detector that detects a reproduction beam emitted from the optical information recording medium;
a second irradiation optical system of the reference beam to the optical information recording medium; and
a second light-reducing element that is placed in an optical path of the reference beam in the second irradiation optical system, and that reduces light intensity of the reference beam irradiated to an area, in the optical information recording medium, in which first information other than second information recorded with the information beam of which light intensity is reduced is recorded.

5. The apparatus according to claim 4, further comprising:
a drive unit that moves the second light-reducing element; and
a control unit that controls the drive unit so as to move the second light-reducing element into the optical path in which the reference beam is irradiated, when the information recorded in the optical information recording medium is to be reproduced.

6. An optical information recording medium comprising:
an information recording layer that can record information as hologram by using interference fringes produced due to interference between an information beam that carries the information and a reference beam; and
a light reducing layer that is laminated on a surface of the information recording layer on a side of emitting a reproduction beam from the information recorded in the information recording layer with part of the information beam of which light intensity is reduced, and that reduces light intensity of the reproduction beam in a first area other than a second area, in the information recording layer, in which the information is recorded with the part of the information beam of which light intensity is reduced.

7. An optical information recording medium comprising:
an information recording layer that can record information as hologram by using interference fringes produced due to interference between an information beam that carries the information and a reference beam; and
a light reducing layer that is formed on the information recording layer and reduces light intensity of part of the reproduction beam.

8. An optical information reproducing apparatus comprising:
a detector that can record information as hologram by using interference fringes produced due to interference between an information beam that carries the information and a reference beam, and that detects a reproduction beam emitted from an optical information recording medium that records information with part of the information beam of which light intensity is reduced; and
a light-reducing element that is placed in an optical path of the reproduction beam extending from the optical information recording medium to the detector, and that reduces light intensity of the reproduction beam emitted from a first area other than a second area in which information is recorded with the part of the information beam of which light intensity is reduced.

9. An optical information reproducing apparatus comprising:
a light-reducing element that is placed in an optical path in which a reproduction beam is irradiated to an optical information recording medium that can record information as hologram by using interference fringes produced due to interference between an information beam that carries the information and a reference beam, and that reduces light intensity of the reference beam irradiated to an area, in the optical information recording medium, in which first information other than second information recorded with the information beam of which light intensity is reduced is recorded; and
a detector that detects the reproduction beam.
